(19) United States
(12) Patent Application Publication
(10) Pub. No.: US 2025/0339861 A1
(43) Pub. Date: Nov. 6, 2025

(54) FRAME UNIT

(71) Applicant: CANON KABUSHIKI KAISHA, Tokyo (JP)

(72) Inventors: HIDEKAZU KOSE, Tokyo (JP); AKIRA FUJIMOTO, Tokyo (JP); YUKIO FURUKAWA, Kanagawa (JP)

(21) Appl. No.: 19/267,052

(22) Filed: Jul. 11, 2025

Related U.S. Application Data
(63) Continuation of application No. PCT/JP2024/000515, filed on Jan. 12, 2024.

(30) Foreign Application Priority Data
Jan. 12, 2023 (JP) 2023-003301
Dec. 26, 2023 (JP) 2023-219840

(51) Int. Cl. B01L 9/00

(52) U.S. Cl. CPC B01L 9/52; B01L 2200/025; B01L 2200/0689

(57) ABSTRACT

A frame unit configured to be attached to an array plate includes a bank member (2) that is arranged so as to surround a predetermined area on one surface of the array plate and has an opening for holding a liquid, a seal member that is arranged between the one surface of the array plate and the bank member, and a clip member that contacts the other surface of the array plate to support the array plate and detachably supports the bank member, wherein the bank member has a first position reference configured to come into contact with an end surface located at one end of the array plate in a long-side direction.

### CROSS-REFERENCE TO RELATED APPLICATIONS

This application is a Continuation of International Patent Application No. PCT/JP2024/000515, filed Jan. 12, 2024, which claims the benefit of Japanese Patent Applications No. 2023-003301, filed Jan. 12, 2023, and No. 2023-219840, filed Dec. 26, 2023, all of which are hereby incorporated by reference herein in their entirety.

### BACKGROUND

### Field of the Technology

The present invention relates to a frame unit that is attached to an array plate.

### Description of the Related Art

There are known array plates in which a large number of biological substances such as proteins, peptides, and nucleic acids are fixed in spots on a substrate. The array plates are also called protein array, peptide array, deoxyribonucleic acid (DNA) array, and the like. By using an array plate, the biological substances fixed on the substrate can be reacted with substances in a sample, and the interactions between them can be observed at once. This allows comprehensive analysis of interactions with a large number of substances including samples derived from living organisms such as blood, cell extracts, saliva, and interstitial fluid.

As a method for measuring a sample using an array plate, there is known a method by which spots where an interaction of interest has occurred are selectively fluorescently labeled to obtain optical information. As a device for observing a fluorescently labeled sample, there is known a confocal laser microscope, for example.

### CITATION LIST

### Patent Literature

PTL 1: United States Patent Application Publication No. 2013/0171043

### Non Patent Literature

NPL 1: “Chamber Slide” on the web site at the URL <http://www.phoenixsci.co.jp/products/chamberslide.html>

At measurement of a sample using an array plate, a reaction process may be performed in which a liquid reagent is supplied to and discharged from a biological substance on the array plate, and a measurement process may be performed in which optical measurement is performed on the biological substance after the reaction. In order to reduce the burden on operators in the reaction process and the measurement process, there have been inspection apparatuses under development that generate a desired interaction in a biological substance on the array plate and then measure the biological substance after the reaction. The array plates used in such inspection apparatuses are required to have a structure for holding a liquid reagent used for inducing a reaction, and to enable optical observation of the substance after the reaction.

As an example of an inspection tool having such a structure, there is known a chamber slide used for cell culture.

For example, the chamber slide discussed in U.S. Patent Application Publication No. 2013/0171043 prevents a reagent from leaking out of a reagent holding member by bonding a bottom plate constituting the bottom surface of the reagent holding member to a bank member constituting the side surfaces of the reagent holding member. The member constituting the slide is made of a plastic material that exhibits low birefringence and has an autofluorescence property similar to that of a cover glass, and can be used for fluorescence observation.

In addition, “Chamber Slide” on the web site at the URL <http://www.phoenixsci.co.jp/products/chamberslide.html> discusses a configuration in which a seal member and a chamber member are laid over a slide glass, and these are pressed and clamped by a snap-fit element of a base portion placed on the lower surface of the slide glass to form a liquid-tight holding member. An opening is provided on the bottom surface of the base portion to enable microscopic observation from the back side of the slide glass.

The chamber member has a rectangular frame unit located inside the glass surface of the slide glass and inner walls that divide the area surrounded by the frame unit into a plurality of chamber compartments.

Some biological substances to be observed are easily denatured by heat or chemicals. The chamber slide discussed in U.S. Patent Application Publication No. 2013/0171043 cannot be applied to array plates including biological substances because the bank member and the bottom plate are bonded by an adhesive or heat.

The amount of a biological substance on the array plate is very small. Thus, if an external force is applied, the biological substance will be easily peeled off from the surface of the array plate to be inspected. Therefore, when attaching a seal or a chamber to the array plate, it is necessary to avoid these members from contacting with the biological substance. In the case of applying a structure similar to the chamber slide discussed in “Chamber Slide” on the web site at the URL <http://www.phoenixsci.co.jp/products/chamberslide.html> to an array plate, the chamber will be placed on the array plate for assembly, so the chamber may be dropped onto the biological substance by mistake during assembly.

The present invention has been made in view of the above-described issues, and is directed to improving the ease of attaching a frame unit to an array plate.

### SUMMARY

According to the present invention, a frame unit configured to be attached to an array plate includes a bank member that is arranged so as to surround a predetermined area on one surface of the array plate and has an opening for holding a liquid, a seal member that is arranged between the one surface of the array plate and the bank member, and a clip member that contacts the other surface of the array plate to support the array plate and detachably supports the bank member, wherein the bank member has a first position reference configured to come into contact with an end surface located at one end of the array plate in a long-side direction.

Features of the present disclosure will become apparent from the following description of embodiments with reference to the attached drawings.

### BRIEF DESCRIPTION OF THE DRAWINGS

FIG. 1 is a diagram schematically illustrating an internal structure of an inspection apparatus.

FIG. 2 is an exploded perspective view of a frame unit in a first exemplary embodiment.

FIG. 3 is a perspective view of an array plate.

FIG. 4 is a perspective view of a bank member in the first exemplary embodiment.

FIG. 5 is a perspective view of the bank member in the first exemplary embodiment.

FIG. 6 is a perspective view of a seal member in the first exemplary embodiment.

FIG. 7 is a perspective view of a clip member in the first exemplary embodiment.

FIG. 8 is a top view of the clip member in the first exemplary embodiment.

FIG. 9 is a cross-sectional view taken along line A-A in FIG. 8.

FIG. 10A is a perspective view of the frame unit and the array plate in the first exemplary embodiment.

FIG. 10B is a perspective view of the frame unit and the array plate in the first exemplary embodiment.

FIG. 11 is a perspective view of the bank member, the seal member, the array plate, and the clip member in the first exemplary embodiment.

FIG. 12 is a cross-sectional view taken along line B-B in FIG. 10A.

FIG. 13 is a perspective view of a seal member in a second exemplary embodiment.

FIG. 14 is a perspective view of a bank member in the second exemplary embodiment.

### DESCRIPTION OF THE EMBODIMENTS

Hereinafter, preferred exemplary embodiments of the present invention will be described with reference to the accompanying drawings.

### First Exemplary Embodiment

In the exemplary embodiment described below, an example will be taken in which a frame unit to which the present invention is applied is used in an inspection apparatus used to perform a reaction process in which a liquid reagent is supplied to and discharged from a biological substance on an array plate, and a measurement process in which an optical measurement is performed on the biological substance after the reaction.

### <Inspection Apparatus>

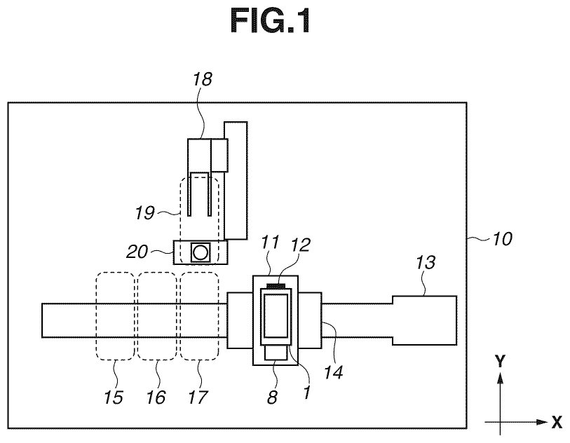

FIG. 1 is a diagram schematically illustrating an internal structure of an inspection apparatus 10 as viewed from the ceiling.

The inspection apparatus 10 is used to perform a reaction process and a measurement process on an array plate 8 to which a frame unit 1 is attached (hereinafter, also referred to as framed array plate 8).

The framed array plate 8 is placed on a holder 11. The holder 11 is provided with a shaking mechanism capable of shaking. The holder 11 is placed on a table 14 movable in an X direction by an actuator 13. The holder 11 is provided with positioning pins (not illustrated), and the positioning pins are inserted into through holes 56 and 57 provided in the frame unit 1 as described below. This allows the framed array plate 8 to be held on the holder 11 even when shaking or moving operations are performed. The holder 11 also includes a temperature control block 12, which is in thermal contact with the framed array plate 8 placed on the holder 11.

In the inspection apparatus 10, a drainage area 15 where the liquid reagent is drained from the framed array plate 8 and a liquid supply area 16 where the liquid reagent is supplied during the reaction step are arranged to be aligned in the X direction. When draining the liquid reagent, the actuator 13 is driven to move the table 14 such that the framed array plate 8 to be drained is positioned in the drainage area 15. When supplying the liquid reagent, the actuator 13 is driven to move the table 14 such that the framed array plate 8 to be supplied with the liquid reagent is positioned in the liquid supply area 16.

Further, in the inspection apparatus 10, a relay area 17 is arranged so as to be aligned with the liquid supply area 16 in the X direction. The framed array plate 8 that has undergone the reaction process is moved to the relay area 17 by driving of the actuator 13, and is handed over to a transport hand 18 that moves in the Y direction. The framed array plate 8 having been handed over to the transport hand 18 is then moved in the Y direction by the transport hand 18 and transferred to a measurement area 19. The measurement process is then performed in the measurement area 19. The transport hand 18 can be configured to be capable of transporting the framed array plate 8 even within the measurement area 19. Transferring the framed array plate 8 to be measured within the measurement area 19 by the transport hand 18 enables scanning in the Y direction in the measurement process.

The measurement system 20 is a confocal laser microscope, and includes an illumination optical system, a fluorescence detection optical system, and a two-dimensional scanning system, none of which are illustrated in the drawing. The illumination optical system has a function of focusing and emitting a laser beam onto an object to be observed. The fluorescence detection optical system has a function of detecting the amount of fluorescence from spots labeled with fluorescent probes. The two-dimensional scanning system has a function of two-dimensionally scanning the array plate or the optical system to acquire a fluorescence image of spots on the array plate. In the inspection apparatus 10, the two-dimensional scanning system is arranged below the framed array plate 8 to perform reciprocating scanning in the X direction.

A two-dimensional fluorescent image of the spot area on the framed array plate 8 can be obtained by performing, in combination, reciprocating scanning in the X direction (main scanning) by the operation system and scanning in the Y direction (sub-scanning) by the transport hand 18. The transport hand 18 has a bifurcated shape and holds the array plate 8 without overlapping the spot area as viewed from below, and does not interfere with measurement of the entire spot area.

### <Frame Unit>

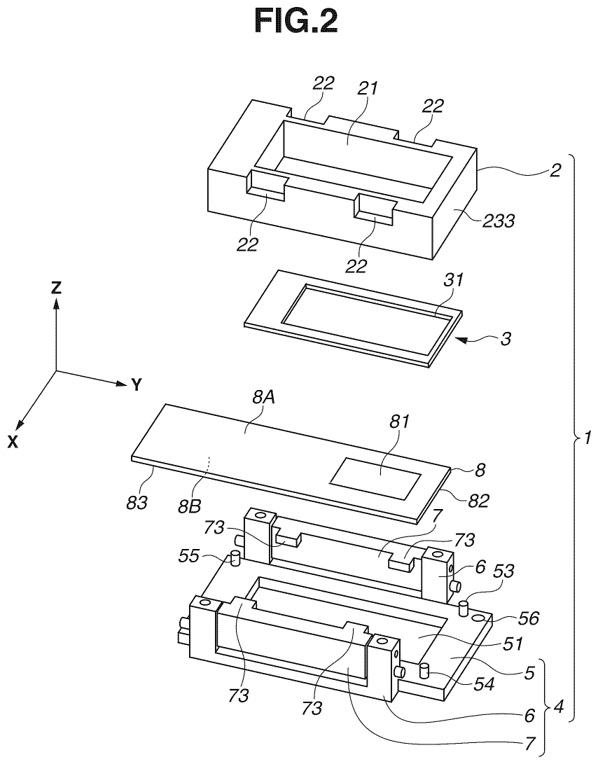

FIG. 2 is an exploded perspective view of the frame unit 1 and the array plate 8 as viewed obliquely from above.

As illustrated in FIG. 2, the array plate 8 has a substantially rectangular plate shape with a predetermined length-to-breadth ratio (aspect ratio), and has a spot area 81 with a plurality of spots on one surface (surface to be inspected 8A). The spot area 81 is arranged close to one end of the array plate 8 in the long-side direction. The array plate 8 has an extension member on the other end in the long-side direction to which an identifier (not illustrated) that identifies each plate with a unique serial number or the like is provided. The identifier is arranged in an area that does not overlap the spot area.

In this specification, the X axis is taken in parallel to the short-side direction of the array plate 8, the Y axis is taken in parallel to the long-side direction, and the Z axis is taken to be perpendicular to the X axis and the Y axis.

The array plate 8 has an end surface 82 at one end side close to the spot area 81 in the long-side direction (Y direction). With regard to the positive and negative signs of the Y direction, that is, the positive and negative directions of the Y axis, the direction from the spot area 81 to the side with the end surface 82 is set as positive. The positive direction of the Y axis corresponds to the direction in which the end surface 82 is brought closer to a first position reference 231 when the array plate 8 is brought into contact with the first position reference 231 of the bank member 2. In other words, the positive direction of the Y axis corresponds to the direction in which the array plate 8 is inserted into the bank member 2 when the frame unit 1 is assembled to the array plate.

The array plate 8 has a pair of side surfaces 83 extending in parallel in the short-side direction (X direction) to sandwich the spot area 81. With regard to the positive and negative signs of the Z direction, that is, the positive and negative directions of the Z axis, the direction from a back surface 8B toward the surface to be inspected 8A is set as positive in an upright arrangement in which the spot area 81 faces vertically upward as illustrated in FIG. 2. The positive direction of the X axis corresponds to the direction in which a right-handed screw advances when rotated right from the Y axis toward the Z axis as illustrated in FIG. 2. Right rotation corresponds to clockwise rotation as viewed from the negative to positive directions of the X axis.

The vertical upward direction and downward direction may be referred to as the direction opposite to the direction of gravity and the direction of gravity, respectively. When the array plate 8 is stood upright, the surface facing the positive direction of the Z axis will be called the surface to be inspected, and the surface facing the negative direction will be called the back surface. The positive direction of the Y axis will be called the backward direction, the negative direction of the Y axis will be called the forward direction. The positive direction of the X axis will be called the rightward direction, the negative direction of the X axis will be called the leftward direction. The positive direction of the Z axis will be called the upward direction, and the negative direction of the Z axis will be called the downward direction.

The surface to be inspected 8A may be alternatively referred to as a front surface 8A, an upper surface 8A, or an inspection target surface 8A. Similarly, the back surface 8B may be alternatively referred to as a rear surface 8B or a lower surface 8B.

The upright arrangement of the array plate 8 corresponds to an arrangement in which the surface to be inspected 8A faces vertically upward. The inverted arrangement of the array plate 8 corresponds to an arrangement in which the surface to be inspected 8A faces vertically downward. For the bank member 2, the seal member 3, and the clip member 4, areas in the Z direction, such as front-to-rear surfaces and upper-to-lower surfaces, may be specified based on the upright arrangement of the array plate 8.

The frame unit 1 has a seal member 3 that is closed in the circumferential direction because the bank member 2 and the front surface of the array plate 8 having the spot area 81 form a liquid-tight contact surface that is closed in the circumferential direction.

When the frame unit 1 is attached to the array plate 8 and a predetermined liquid is stored therein, the liquid forms a waterline on the bank member 2 at a position corresponding to the level of the liquid. The bank member 2 is brought into liquid-tight contact with the array plate 8 via the seal member 3 that is closed in the circumferential direction, thereby holding the liquid on the front side of the array plate 8.

When the frame unit 1 is attached to the array plate 8, the height of the bank member is determined according to the height direction of the bank member 2 that corresponds to the thickness direction of the array plate 8. The height of the bank member corresponds to the Z direction in FIG. 2.

The X-axis, Y-axis, and Z-axis for the bank member 2, the seal member 3, and the clip member 4 are the same as those for the array plate 8.

The frame unit 1 includes the bank member 2, the seal member 3, and the clip member 4.

The bank member 2 is formed of a rectangular frame and has an opening 21 for holding a liquid reagent in the center. The opening 21 is arranged so as to surround the spot area 81 on the surface to be inspected of the array plate 8.

The seal member 3 is arranged between the surface to be inspected of the array plate 8 and the bank member 2. The seal member 3 has an opening 31 corresponding to the opening 21 of the bank member 2, and connects the bank member 2 and the array plate 8 in a liquid-tight manner around the openings 21 and 31.

The clip member 4 contacts the back surface 8B of the array plate 8 to support the array plate 8, and also detachably supports the bank member 2. When the frame unit 1 is attached to the array plate 8, the bank member 2, the seal member 3, and the array plate 8 are pressed and clamped, as described below.

### <Array Plate>

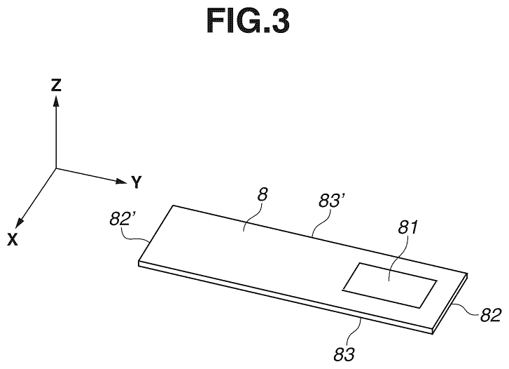

The array plate 8 will be described with reference to FIG. 3.

FIG. 3 is a perspective view of the array plate 8 in an upright position.

The array plate 8 has a rectangular glass slide as a base plate, and has the spot area 81 provided in the surface to be inspected 8A. The spot area 81 is an area having a plurality of spots on which a biological substance serving as a sample is fixed. The spot area 81 is arranged at a distance from the end surfaces and side surfaces of the array plate 8, and the area around the spot area 81 is used as an area for contact with the seal member 3 when the frame unit 1 is attached.

The array plate 8 has a length-to-breadth ratio (aspect ratio) and extends in the long-side and short-side directions. The array plate 8 has a shape of a substantially rectangular parallelepiped with a substantially rectangular main surface. The end surfaces 82, 82′ located in the long-side direction and the side surfaces 83, 83′ located in the short-side direction correspond to the peripheral edges of the array plate 8. The end surfaces 82, 82′ and the side surfaces 83, 83′ may be formed substantially perpendicular to the main surface having the largest area among the six surfaces of the array plate 8 that is considered as a rectangular parallelepiped. The sites of transition between the end surfaces 82, 82′, the side surfaces 83, 83′ and the main surface may have transition portions that are convex outward from the viewpoint of preventing breaking, chipping, and the like. Similarly, the end surfaces 82, 82′ and the side surfaces 83, 83′ may have cross sections that protrude outward in the X direction or Y direction in FIG. 3.

### <Bank Member>

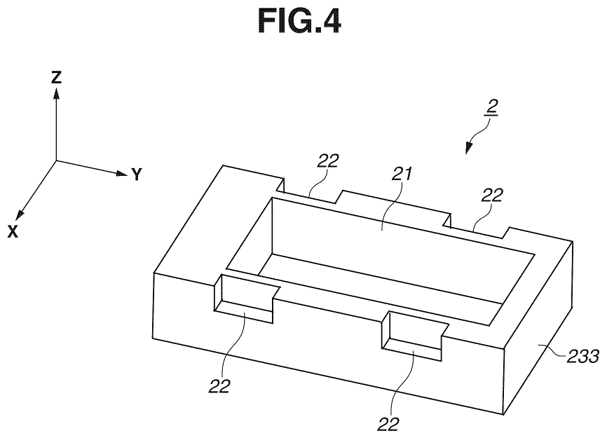

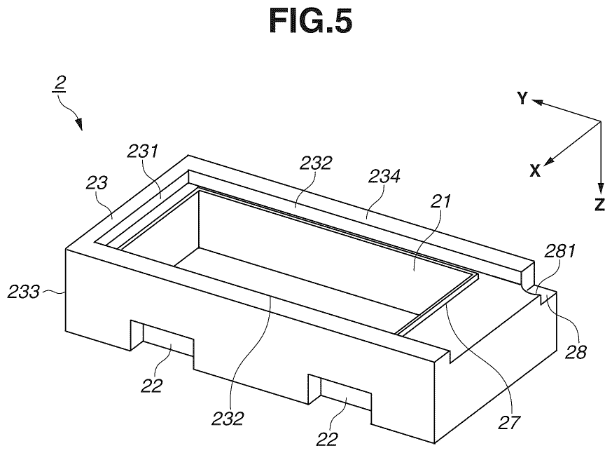

The bank member 2 will be described with reference to FIGS. 4 and 5.

FIG. 4 is a perspective view of the bank member 2 in an upright position.

The bank member 2 is formed of a rectangular frame, and has the opening 21 in the center for holding a liquid reagent. The opening 21 is larger (wider in area) than the spot area 81 of the array plate 8, and is arranged so as to surround the spot area 81. That is, the main body of the bank member 2 does not overlap the spot area 81.

The bank member 2 has concave portions 22 formed on both sides of the upper side (positive side in the Z direction) of the long-side bank member extending in the Y direction. The concave portions 22 constitute fit-receiving portions into which convex portions 73 of a fitting portion 7 of the clip member 4 are fitted, as described below.

FIG. 5 is a perspective view of the bank member 2 in an inverted position.

The bank member 2 has a convex portion 23 on the lower surface (surface on the negative side of the Z direction), along the direction in which a pair of parallel long-side bank portions extends in the Y direction and the direction in which the Y-direction positive-side one of the X-direction bank portions extending in the X direction extends. The lower surface (surface on the negative side of the Z direction) of the convex portion 23 constitutes a lower surface 234 that contacts the clip member 4. The inner side surface 231 of the convex portion 23 on the positive side of the Y direction contacts the end surface 82 of the array plate 8, thereby serving as the first position reference for positioning the array plate 8 in the long-side direction. Inner-side surfaces 232 of the convex portion 23 extending in the Y direction contact corresponding ones of the side surfaces 88 of the array plate 8, thereby serving as a second position reference for positioning the array plate 8 in the short-side direction. The distance between the left and right side surfaces 232 is longer than the short-side length of the array plate 8 and the seal member 3, and the array plate 8 and the seal member 3 can be installed between the side surfaces 232. The first position reference 231 and the second position reference 232 in the present exemplary embodiment are both planes parallel to the Z direction, but may have a tapered or R-shaped cross section that is partially inclined with respect to the Z direction. The first position reference 231 and the second position reference 232 may both have protrusions (not illustrated) that protrude in the Y direction and the X direction, respectively, so as to locally contact the end surfaces 82 and the side surfaces 83 of the array plate 8. The protrusions may also be provided as two protrusions that are spaced apart from each other on the sides along which the convex portion 23 extends.

The bank member 2 also has a convex portion 27 on the lower surface along the outer edge of the opening 21. As will be described below, the convex portion 27 is adapted to contact the seal member 3.

The bank member 2 has a cutout 28 formed at the left front corner of the lower surface, and has an arc-shaped side surface 281 facing leftward. As will be described below, the bank member 2 and the clip member 4 can be positioned by bringing a positioning pin 55 of the clip member 4 into contact with the side surface 281.

### <Seal Member>

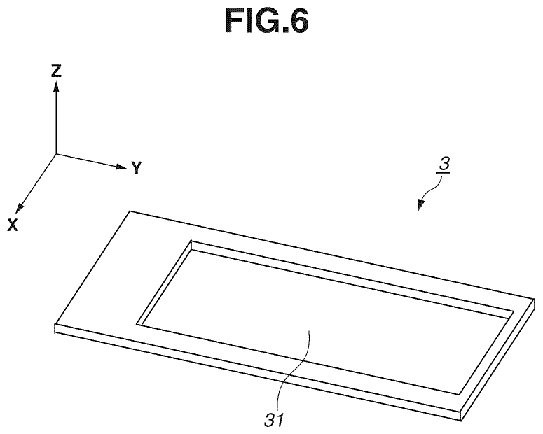

The seal member 3 will be described with reference to FIG. 6.

FIG. 6 is a perspective view of the seal member 3 in an upright position.

The seal member 3 is made of an elastic member such as rubber and has a rectangular thin plate shape. The seal member 3 has the opening 31 in the center.

The opening 31 has a shape similar to, but slightly smaller than, the convex portion 27 on the outer edge of the opening 21 of the bank member 2. When the frame unit 1 is assembled, the convex portion 27 comes into contact with the periphery of the opening 31 of the seal member 3.

Similarly to the opening 21 of the bank member 2, the opening 31 is larger than the spot area 81 of the array plate 8 and is arranged so as to surround the spot area 81. That is, the main body of the seal member 3 does not overlap the spot area 81.

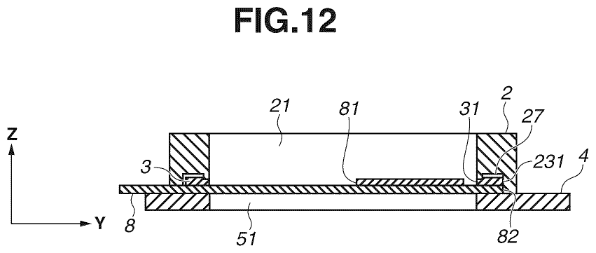

Next, the thickness of the seal member 3 will be described. A thickness D of the seal member 3 is designed to satisfy D>d where the distance between the convex portion 27 and the surface to be inspected 8A of the array plate 8 on which the bank member 2 is placed without the seal member 3 interposed between the array plate 8 and the bank member 2 is represented by d. Accordingly, when the bank member 2, the seal member 3, and the array plate 8 are pressed and clamped, the convex portion 27 bites into the seal member 3, thereby ensuring liquid-tightness (see FIG. 12).

### <Clip Member>

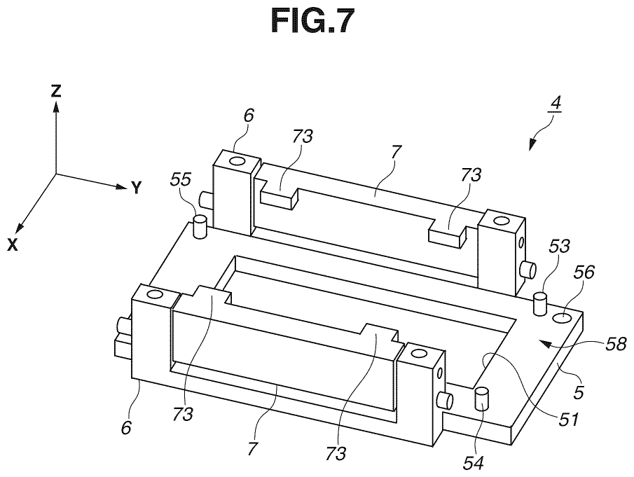

The clip member 4 will be described with reference to FIGS. 7 to 10A and 10B.

FIG. 7 is a perspective view of the clip member 4 in an upright position.

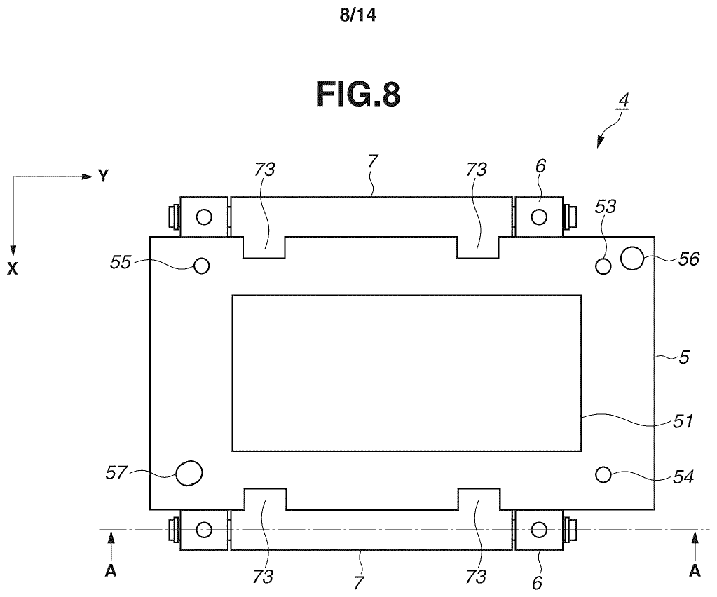

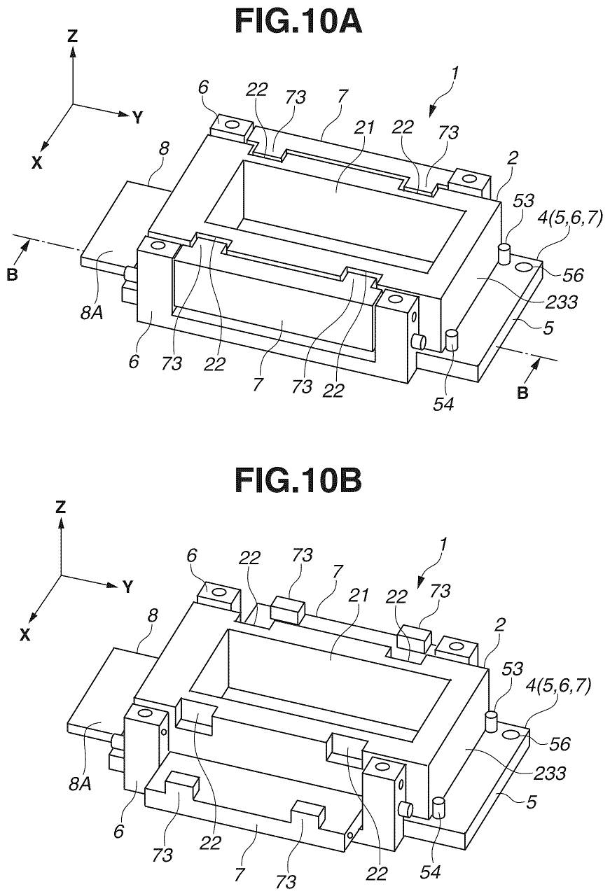

The clip member 4 includes a thin plate-like base portion 5, support portions 6 provided on the left and right sides of the base portion 5, and the fitting portion 7 supported by the support portions 6. An upper surface 58 of the base portion 5 contacts the lower surface 234 of the bank member 2 and the back surface 8B of the array plate 8. The support portions 6 rotatably support the fitting portion 7. The fitting portion 7 includes the convex portions 73. The convex portions 73 are arranged at positions where they can fit into the concave portions 22 of the bank member 2 when the frame unit 1 is assembled. The fitting portion 7 is movable between a fixed state in which the convex portions 73 are fitted into the concave portions 22, and an unfixed state in which the convex portions 73 and the concave portions 22 are released from fitting. Then, when the frame unit 1 is assembled and the convex portions 73 of the fitting portion 7 are fitted into the concave portions 22 (see FIGS. 8, 10A, and 10B), the bank member 2, the seal member 3, and the array plate 8 are pressed and held between the upper surface 58 of the base portion 5 and the convex portions 73.

FIG. 8 illustrates a top view of the clip member 4 in an upright position.

The base portion 5 has an opening 51 formed in the center, and the opening 51 is larger than the spot area 81 of the array plate 8. Using this opening 51, it is possible to optically measure the entire spot area 81 from the back surface 8B side of the array plate 8 in a state where the frame unit 1 is attached to the array plate 8.

The base portion 5 has a pin for positioning the bank member 2 on the upper surface 58.

The base portion 5 has a first positioning pin 53 provided on the left back side (negative side of the X-axis direction, positive side of the Y-axis direction) on the upper surface 58. The base portion 5 also has a second positioning pin 54 provided on the right back side (positive side of the X-axis direction, positive side of the Y-axis direction) of the upper surface 58, spaced apart from the first positioning pin 53. The first positioning pin 53 and the second positioning pin 54 are arranged at the same position in the Y direction. The bank member 2 and the clip member 4 can be positioned in the Y direction by bringing an end surface 233 on the back side (positive side of the Y-axis direction) of the bank member 2 into contact with the positioning pins 53, 54. The positioning structure for positioning the bank member 2 and the clip member 4 in the long-side direction (Y direction) of the array plate 8 as described above constitutes the third position references 53, 54.

The base portion 5 also has a third positioning pin 55 provided on the left front side (negative side of the X-axis direction, negative side of the Y-axis direction) of the upper surface 58. When the end surface 233 on the back side (positive side of the Y-axis direction) of the bank member 2 contacts the positioning pins 53, 54, a portion of the side surface 281 of the bank member 2 contacts the third positioning pin 55. Accordingly, the bank member 2 and the clip member 4 can be positioned in the X direction. The positioning structure for positioning the bank member 2 and the clip member 4 in the short-side direction of the array plate 8 as described above constitutes the fourth position reference 55.

The upper surface 58 of the base portion 5 is larger than the lower surface 234 of the bank member 2, and the bank member 2 and the clip member 4 can be positioned in the Z direction by bringing the lower surface 234 of the bank member 2 into contact with the upper surface of the base portion 5. The positioning structure for positioning the bank member 2 and the clip member 4 in the thickness direction (Z direction) of the array plate 8 as described above constitutes the fifth position reference 58. The third position references 53, 54, the fourth position reference 55, and the fifth position reference 58 are the corresponding position references of the bank member 2. Third to fifth position references (not illustrated) for positioning the base portion 5, which is an element of the clip member 4, may be provided on the bank member 2 rather than on the base portion 5.

The base portion 5 has a round hole 56 and an elongated hole 57, which are through holes, into which the positioning pins of the holder 11 are inserted. The round hole 56 is arranged outside the first positioning pin 53, and the elongated hole 57 is arranged on a diagonal line of the base portion 5 with respect to the round hole 56. When the positioning pins of the holder 11 are inserted into the round hole 56 and the elongated hole 57, the base portion 5 can be positioned in the X direction and the Y direction with respect to the holder 11.

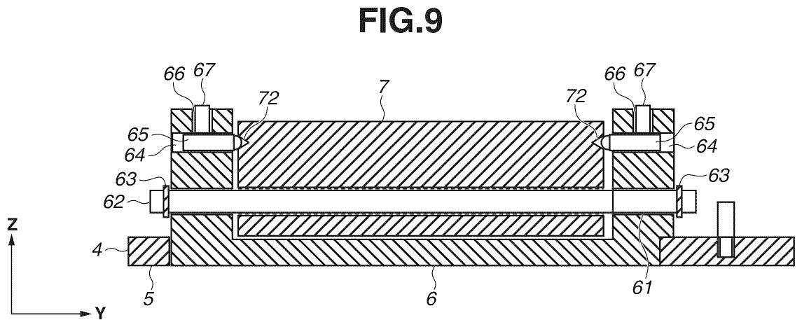

FIG. 9 is a cross-sectional view taken along line A-A in FIG. 8.

The support portion 6 and the fitting portion 7 respectively have a through hole 61 and a through hole 71 extending in the Y direction. A rotation shaft 62 is inserted into the through hole 61 and the through hole 71. Both ends of the rotation shaft 62 are supported by the support portion 6, and the fitting portion 7 is rotatable around the rotation shaft 62. E-rings 63 are provided on both ends of the rotation shaft 62 to prevent the rotation shaft 62 from coming off.

The support portion 6 includes plungers 65 for determining the rotation angle of the fitting portion 7. The plungers 65 are inserted into through holes 64 formed in the support portion 6, and are fixed to the support portion 6 by set screws 67 that are inserted into screw holes 66 provided so as to intersect with the through holes 64. In addition, conical concave portions 72 are provided on the side surfaces of the fitting portion 7 so as to pass through the centers of the through holes 64, and are engaged with the tips of the plungers 65.

FIGS. 10A and 10B are perspective views of the seal member 3, the array plate 8, and the bank member 2 placed and held upright on the clip member 4.

When the fitting portion 7 is rotated in a direction approaching the bank member 2, the convex portions 73 are fixed in place and fitted into the concave portions 22, as illustrated in FIG. 10A. In this state, the bank member 2, the seal member 3, and the array plate 8 are pressed and held between the upper surface 58 of the base portion 5 and the lower surfaces of the convex portions 73, and a frictional force acts between the lower surfaces of the convex portions 73 and the upper surfaces of the concave portions 22. The rotation angle of the fitting portion 7 is maintained by this frictional force, so that the array plate 8 will not come off the frame unit 1 even if it is shaken or transported.

On the other hand, when a force greater than the frictional force is applied to the fitting portion 7 in a direction away from the bank member 2, the convex portions 73 come off from the concave portions 22 as illustrated in FIG. 10B, resulting in the unfixed state in which the convex portions 73 and the concave portions 22 are released from fitting.

In this manner, the clip member 4 can be easily attached to and detached from the bank member 2 without using any special tools.

### <Assembly of Frame Unit>

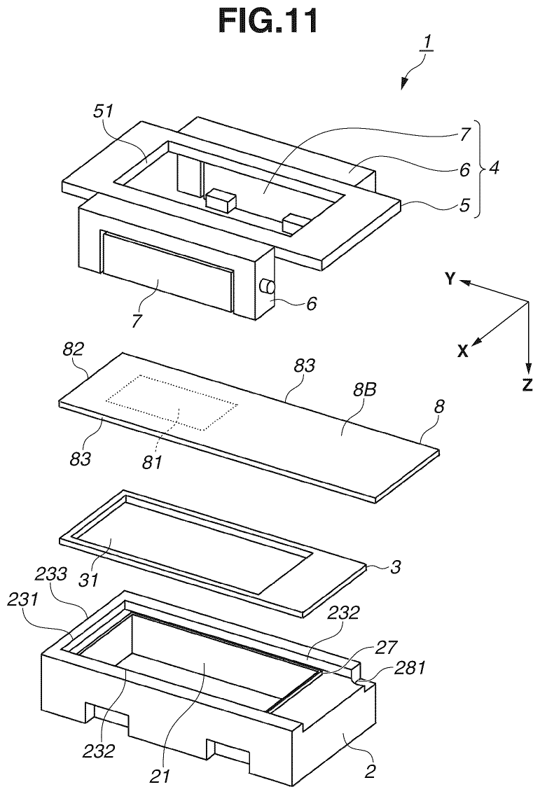

Next, a procedure for assembling the frame unit 1 will be described with reference to FIG. 11.

FIG. 11 is a perspective view of the bank member 2, the seal member 3, the array plate 8, and the clip member 4 in inverted positions.

To assemble the frame unit 1, first, the bank member 2 is inverted such that the lower surface of the bank member 2 faces the ceiling of the inspection apparatus 10.

Next, the seal member 3 is placed on the bank member 2 such that the convex portion 27 of the bank member 2 contacts the periphery of the opening 31 of the seal member 3 and the convex portion 27 does not overlap the opening 31.

Next, the array plate 8 is inverted and the end surface 82 of the array plate 8 is brought into contact with the side surface 231 of the bank member 2. Then, the array plate 8 is placed on the bank member 2 while the side surfaces 83 of the array plate 8 are brought into contact with the corresponding side surfaces 232 of the bank member 2.

Next, the clip member 4 is inverted and placed on the array plate 8 while the positioning pins 53, 54, and 55 are brought into contact with the end surface 233 and the side surface 281 of the bank member 2, respectively. Then, the fitting portion 7 is rotated and brought into the fixed state.

Thereafter, the frame unit 1 is stood upright, thereby completing the framed array plate 8.

In this way, in the frame unit 1 according to the present exemplary embodiment, the array plate 8 can be installed while being positioned with respect to the bank member 2. The spot area 81 does not contact the bank member 2 or the seal member 3 when the array plate 8 is being installed, so that the spot area 81 can be prevented from damaging. Since the spot area 81 faces downward during assembly of the frame unit 1, the spot area 81 will not be damaged even if the clip member 4 is dropped on the array plate 8 or brought into contact with the array plate 8 in an incorrect position.

In this manner, the ease of attaching the frame unit 1 to the array plate 8 can be improved.

Next, the positional relationship among the bank member 2, the seal member 3, the array plate 8, and the clip member 4 in the assembled frame unit 1 will be described with reference to FIG. 12.

FIG. 12 is a cross-sectional view taken along line B-B in FIG. 10A.

When the frame unit 1 is assembled, the bank member 2 and the seal member 3 are fixed so as not to overlap the spot area 81. Therefore, when a liquid reagent is supplied to the opening 21 of the bank member 2, the reagent can react with the biological substance over the entire spot area 81.

The opening 51 of the clip member 4 is arranged to have at least a portion overlapping with the opening 21 of the bank member 2, which makes it possible to optically measure the entire spot area 81 of the array plate 8 from the back surface 8B side.

In the present exemplary embodiment, the right side surface 83 of the array plate 8 is in contact with the right side surface 232 of the convex portion 23 of the bank member 2, but the left side surface 83 of the array plate 8 may be in contact with the left side surface 232 of the convex portion 23. Alternatively, the user may be allowed to arbitrarily select whether to contact the side surfaces on the left or right side.

In the present exemplary embodiment, the bank member 2 is provided with the concave portions 22, and the clip member 4 is provided with the convex portions 73, but the opposite may be true, with the bank member 2 provided with convex portions and the clip member 4 provided with concave portions.

In the present exemplary embodiment, the frictional force acting between the convex portions 73 of the fitting portion 7 and the concave portions 22 of the bank member 2 is used as a method for maintaining the fitting portion 7 in the fixed state. However, the fixed state may be maintained by a force other than the frictional force, such as a force from a snap-fit structure or attraction by a magnetic member.

In the present exemplary embodiment, the plungers 65 are used to determine the angle of the fitting portion 7 with respect to the support portion 6. However, positioning may be performed by another method, such as providing abutment surfaces on the support portion 6 and the fitting portion 7.

In the present exemplary embodiment, the holder 11 is provided with positioning pins, and the clip member 4 is provided with the through holes 56 and 57 to position the holder 11 and the clip member 4. However, the present invention is not limited to this. For example, the bank member 2 may be provided with a through hole for inserting the positioning pin of the holder 11. The present invention is not limited to positioning pins and through holes. The holder 11, which serves as the installation member, may be provided with a bonding portion including at least one of a gripping member, a magnetic member, and an attraction member, and at least one of the bank member 2 and the clip member 4 may be provided with a bonded portion including at least one of a gripped portion gripped by the gripping member, a magnetized portion magnetized to the magnetic member, and an attracted portion attracted to the attraction member. The bonded portion is provided at a position different from the side surfaces 231 and 232 that serve as the reference surfaces of the bank member 2.

### Second Exemplary Embodiment

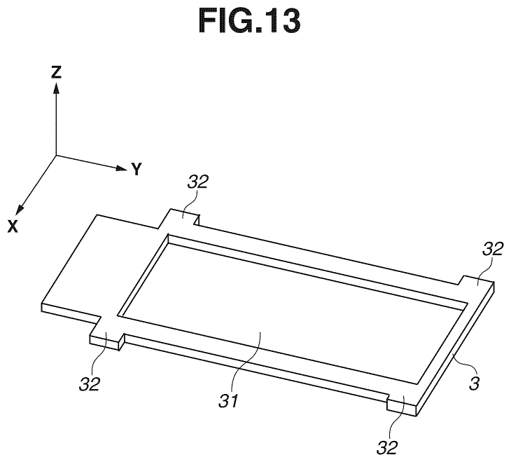

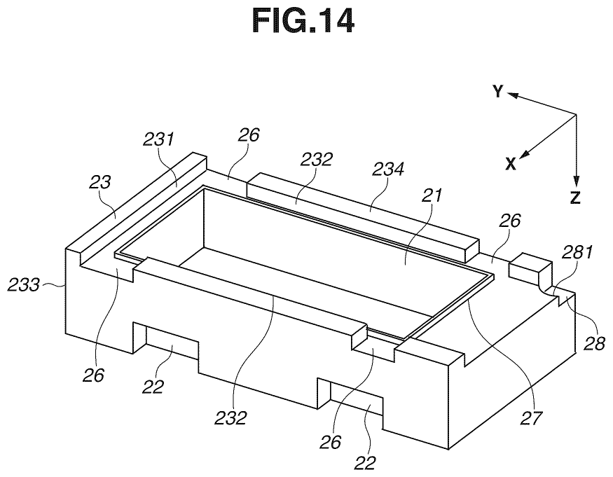

A second exemplary embodiment will be described with reference to FIGS. 13 and 14. A basic configuration of a frame unit according to the second exemplary embodiment is similar to that of the frame unit 1 according to the first exemplary embodiment. The following description will focus on the differences from the first exemplary embodiment, and description of the commonalities with the first exemplary embodiment will be omitted.

In the first exemplary embodiment, when assembling the frame unit 1, the seal member 3 is placed on the bank member 2 such that the convex portion 27 of the bank member 2 contacts the periphery of the opening 31 of the seal member 3, and the convex portion 27 does not overlap the opening 31.

However, since the seal member 3 is made of an elastic material such as rubber, has a rectangular thin plate shape, and has the opening 31 formed in the center, the seal member 3 may become deformed due to the force of gripping the seal member 3 or gravity. Therefore, it is not always easy to install the seal member 3 in the correct position. If the seal member 3 is installed in an incorrect position, a gap will be generated between the convex portion 27 of the bank member 2 and the seal member 3, so that the liquid reagent supplied to the opening 21 of the bank member 2 may leak out of the frame unit 1 through this gap.

In view of this, in relation to the present exemplary embodiment, a form having a sixth position reference and a seventh position reference, which are positioning structures for positioning a bank member 2 and a seal member 3 in the Y direction and the X direction, will be described.

FIG. 13 is a perspective view of the seal member 3 in an upright position.

The seal member 3 has protrusions 32 on the left and right side surfaces. Two protrusions 32 are integrally molded at separate locations on the left side surface of the seal member 3, and two protrusions 32 are integrally molded at separate locations on the right side surface.

FIG. 14 is a perspective view of the bank member 2 in an inverted position.

On the lower surface of the bank member 2, the convex portion 23 has cutouts 26 on the left and right sides corresponding to the protrusions 32 of the seal member 3. The cutouts 26 are slightly larger than the protrusions 32, so that the protrusions 32 can be fitted into the cutouts 26. The protrusions 32 and the cutouts 26 are provided at positions where, when the two are fitted together, the convex portion 27 does not overlap the opening 31 of the seal member 3. When the four protrusions 32 are fitted into the cutouts 26, the seal member 3 can be easily installed at the correct position. Therefore, the four protrusions 32 separated from each other on the seal member 3 constitute a sixth position reference in the Y direction and a seventh position reference in the X direction, corresponding to the long-side direction and the short-side direction of an array plate 8. Similarly, the four cutouts 26 provided on the bank member 2 corresponding to the protrusions 32 constitute a sixth position reference in the Y direction and a seventh position reference in the X direction, corresponding to the long-side direction and the short-side direction of the array plate 8. In the present exemplary embodiment, the sixth position reference and the seventh position reference are provided on both the seal member 3 and the bank member 2. However, the sixth position reference and the seventh position reference may be provided on only either the seal member 3 or the bank member 2.

In the first and second exemplary embodiments described above, appropriately selecting the rigidity of the bank member 2, the seal member 3, and a clip member 4 that constitute a frame unit 1 suppresses the deterioration of measurement performance that may occur when the frame unit is applied to the apparatus that performs optical measurement illustrated in FIG. 1. Hereinafter, the performance deterioration that may occur in optical measurement will be described, and then examples of rigidity conditions for the frame unit to solve this issue will be provided.

As described above, the frame unit 1 presses and clamps the bank member 2, the seal member 3, and the array plate 8 with a convex portion 73 of the clip member 4. At this time, a force of pressing acts on the clip member 4, the bank member 2, the seal member 3, and the array plate 8, so that these members may become deformed. As an example of such deformation, it is considered that the center and its vicinity of the array plate 8 may be deformed in a convex shape upward or downward with respect to an upper surface 58 of a base portion 5. As described above, a measurement system 20 is a confocal laser microscope, and obtains a fluorescent image of spots by two-dimensionally scanning the array plate. Therefore, if the center and its vicinity of the array plate 8 become deformed in a convex shape compared to the outer periphery, the focal position is shifted between the center and the outer periphery of the array plate 8, which may generate unevenness in the detected brightness depending on the measurement position.

Therefore, the above-described deformation is suppressed by selecting the materials of the bank member 2, the seal member 3, and the clip member 4 which constitute the frame unit 1, such that the relationship in magnitude of rigidity among these members satisfies predetermined conditions.

First, a first example for reducing the deformation of the array plate 8 will be provided. In the first example, the upper surface 58 of the base portion 5 of the clip member 4 is formed such that its flatness is sufficiently small in order to use the upper surface 58 as a reference plane in two-dimensionally scanning the base portion 5. The base portion 5 is made of a material higher in rigidity than the bank member 2, the seal member 3, and the array plate 8. The base portion 5 is a member with high rigidity, so it will not deform even when a pressing force is applied. Further, since the flatness of the upper surface 58 is small, the array plate 8 will not deform even when it is pressed against the base portion 5. Moreover, by making the rigidity of the bank member 2 smaller than the rigidity of the base portion 5 and the array plate 8, it becomes possible to, even if the bank member 2 is deformed by pressing, reduce the influence on the array plate 8 and the base portion 5.

In the case of using Young's modulus as an index of rigidity of the members, for example, the materials of the members are selected so as to satisfy inequality (1):

Eb>Ep>Ed>Es (1)

where Eb, Ep, Ed, and Es are the Young's moduli of the base portion 5, the array plate 8, the bank member 2, and the seal member 3, respectively. As a combination of materials that satisfies inequality (1), for example, the seal member is made of an elastic body such as fluoro rubber or ethylene propylene (PP) rubber (Young's modulus is 0.1 MPa or more and 10 MPa or less) and a foamed form of the elastic body. The bank member 2 is made of a resin such as polyethylene or polypropylene (Young's modulus is 20 MPa or more and 3 GPa or less). The array plate 8 is made of optical glass such as borosilicate glass or synthetic quartz (Young's modulus is 50 GPa or more and 80 GPa or less), and the base portion 5 is made of steel such as stainless steel or tungsten (Young's modulus is 100 GPa or more and 500 GPa or less). Young's modulus (Pa) may also be called elastic modulus (Pa).

Next, a second example for reducing deformation of the array plate 8 will be described. In the second example, the array plate 8 is used as a reference plane in performing two-dimensional scanning. The bank member 2, the seal member 3, and the clip member 4 are made of materials lower in rigidity than the array plate, thereby suppressing deformation of the array plate 8. In the case of using Young's modulus as an index for the rigidity of members as in the first example, in the second example, the materials of the members are selected such that the Young's moduli Eb, Ep, Ed, and Es of the base portion 5, the array plate 8, the bank member 2, and the seal member 3 satisfy:

Ep>Eb>Ed>Es (2).

As an example of a combination of materials that satisfies inequality (2), the base portion 5 is made of a resin such as PP with a high Young's modulus, and the bank member 2 is made of a resin such as polyethylene (PE) lower in Young's modulus than the base portion 5. The seal member 3 and the array plate 8 are made of rubber and steel, respectively, as in the first example.

Although the present invention has been described above with reference to the exemplary embodiments, the above exemplary embodiments are merely illustrative of specific examples of the present invention, and the technical scope of the present invention should not be interpreted as being limited by these exemplary embodiments. That is, the present invention can be carried out in various forms without departing from its technical concept or main features.

The disclosure of the exemplary embodiments includes the following configurations.

### Configuration 1

A frame unit configured to be attached to an array plate, including:
a bank member that is arranged so as to surround a predetermined area on one surface of the array plate and has an opening for holding a liquid;
a seal member that is arranged between the one surface of the array plate and the bank member; and
a clip member that contacts the other surface of the array plate to support the array plate and detachably supports the bank member,
wherein the bank member has a first position reference configured to come into contact with an end surface located at one end of the array plate in a long-side direction.

### Configuration 2

The frame unit according to Configuration 1, wherein the bank member has a second position reference configured to come into contact with a side surface located at one end of the array plate in a short-side direction.

### Configuration 3

The frame unit according to Configuration 1 or 2, wherein, in a direction corresponding to the long-side direction of the array plate with the end surface in contact with the first position reference, one of the bank member and the clip member has a third position reference for positioning with respect to the other of the bank member and the clip member.

### Configuration 4

The frame unit according to Configuration 1 or 2, wherein, in a direction corresponding to the short-side direction of the array plate with the end surface in contact with the first position reference, one of the bank member and the clip member has a fourth position reference for positioning with respect to the other of the bank member and the clip member.

### Configuration 5

The frame unit according to any one of Configurations 1 to 3, wherein, in a direction corresponding to a front thickness direction of the array plate with the end surface in contact with the first position reference, one of the bank member and the clip member has a fifth position reference for positioning with respect to the other of the bank member and the clip member.

### Configuration 6

The frame unit according to any one of Configurations 1 to 5, wherein, in a state where the frame unit is attached to the array plate, the bank member, the seal member, and the array plate are pressed and clamped.

### Configuration 7

The frame unit according to any one of Configurations 1 to 6, wherein one of the bank member and the clip member has a fitting portion, and the other has a fit-receiving portion into which the fitting portion fits, and the fitting portion is movable between a fixed state in which the fitting portion is fitted into the fit-receiving portion and an unfixed state in which the fitting with the fit-receiving portion is released.

### Configuration 8

The frame unit according to any one of Configurations 1 to 7, wherein the predetermined area is a spot area with a plurality of spots on which a sample is fixed.

### Configuration 9

The frame unit according to any one of Configurations 1 to 8, wherein the clip member has an opening that is formed on a surface parallel to the other surface of the array plate and is used to optically measure the predetermined area.

### Configuration 10

The frame unit according to any one of Configurations 1 to 9,
wherein an installation portion on which the frame unit is installed is provided with a bonding portion including at least one of a gripping member, a magnetic member, and an attraction member, and
wherein at least one of the bank member and the clip member is provided with a bonded portion including at least one of a gripped portion gripped by the gripping member, a magnetized portion magnetized to the magnetic member, and an attracted portion attracted to the attraction member.

### Configuration 11

The frame unit according to Configuration 10, wherein the bonded portion is provided at a position different from the first position reference.

### Configuration 12

The frame unit according to any one of Configurations 1 to 11, wherein, in a direction corresponding to the long-side direction of the array plate with the end surface in contact with the first position reference, one of the bank member and the seal member has a sixth position reference for positioning with respect to the other of the bank member and the seal member.

### Configuration 13

The frame unit according to any one of Configurations 1 to 12, wherein, in a direction corresponding to the short-side direction of the array plate with the end surface in contact with the first position reference, one of the bank member and the seal member has a seventh position reference for positioning with respect to the other of the bank member and the seal member.

### Configuration 14

The frame unit according to any one of Configurations 1 to 12, wherein an elastic modulus of the bank member is lower than an elastic modulus of the array plate.

### Configuration 15

The frame unit according to Configuration 14, wherein the clip member has a base portion that contacts the other surface and supports the array plate.

### Configuration 16

The frame unit according to Configuration 15, wherein an elastic modulus of the base portion is higher than the elastic modulus of the bank member.

### Configuration 17

The frame unit according to Configuration 16, wherein the elastic modulus of the base portion is higher than the elastic modulus of the array plate.

### Configuration 18

The frame unit according to Configuration 16, wherein the elastic modulus of the base portion is lower than the elastic modulus of the array plate.

The present invention is not limited to the above-described exemplary embodiments, and various modifications and variations can be made without departing from the spirit and scope of the present invention. Therefore, the following claims are appended to apprise the public of the scope of the present invention.

According to the present invention, it is possible to improve the ease of attaching a frame unit to an array plate.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. A frame unit configured to be attached to an array plate, comprising:
a bank member that is arranged so as to surround a predetermined area on one surface of the array plate and has an opening for holding a liquid;
a seal member that is arranged between the one surface of the array plate and the bank member; and
a clip member that contacts the other surface of the array plate to support the array plate and detachably supports the bank member,
wherein the bank member has a first position reference configured to come into contact with an end surface located at one end of the array plate in a long-side direction.

2. The frame unit according to claim 1, wherein the bank member has a second position reference configured to come into contact with a side surface located at one end of the array plate in a short-side direction.

3. The frame unit according to claim 1, wherein, in a direction corresponding to the long-side direction of the array plate with the end surface in contact with the first position reference, one of the bank member and the clip member has a third position reference for positioning with respect to the other of the bank member and the clip member.

4. The frame unit according to claim 1, wherein, in a direction corresponding to the short-side direction of the array plate with the end surface in contact with the first position reference, one of the bank member and the clip member has a fourth position reference for positioning with respect to the other of the bank member and the clip member.

5. The frame unit according to claim 1, wherein, in a direction corresponding to a front thickness direction of the array plate with the end surface in contact with the first position reference, one of the bank member and the clip member has a fifth position reference for positioning with respect to the other of the bank member and the clip member.

6. The frame unit according to claim 1, wherein, in a state where the frame unit is attached to the array plate, the bank member, the seal member, and the array plate are pressed and clamped.

7. The frame unit according to claim 1, wherein one of the bank member and the clip member has a fitting portion, and the other has a fit-receiving portion into which the fitting portion fits, and the fitting portion is movable between a fixed state in which the fitting portion is fitted into the fit-receiving portion and an unfixed state in which the fitting with the fit-receiving portion is released.

8. The frame unit according to claim 1, wherein the predetermined area is a spot area with a plurality of spots on which a sample is fixed.

9. The frame unit according to claim 1, wherein the clip member has an opening that is formed on a surface parallel to the other surface of the array plate and is used to optically measure the predetermined area.

10. The frame unit according to claim 1,
wherein an installation portion on which the frame unit is installed is provided with a bonding portion including at least one of a gripping member, a magnetic member, and an attraction member, and
wherein at least one of the bank member and the clip member is provided with a bonded portion including at least one of a gripped portion gripped by the gripping member, a magnetized portion magnetized to the magnetic member, and an attracted portion attracted to the attraction member.

11. The frame unit according to claim 10, wherein the bonded portion is provided at a position different from the first position reference.

12. The frame unit according to claim 1, wherein, in a direction corresponding to the long-side direction of the array plate with the end surface in contact with the first position reference, one of the bank member and the seal member has a sixth position reference for positioning with respect to the other of the bank member and the seal member.

13. The frame unit according to claim 1, wherein, in a direction corresponding to the short-side direction of the array plate with the end surface in contact with the first position reference, one of the bank member and the seal member has a seventh position reference for positioning with respect to the other of the bank member and the seal member.

14. The frame unit according to claim 1, wherein an elastic modulus of the bank member is lower than an elastic modulus of the array plate.

15. The frame unit according to claim 14, wherein the clip member has a base portion that contacts the other surface and supports the array plate.

16. The frame unit according to claim 15, wherein an elastic modulus of the base portion is higher than the elastic modulus of the bank member.

17. The frame unit according to claim 16, wherein the elastic modulus of the base portion is higher than the elastic modulus of the array plate.

18. The frame unit according to claim 16, wherein the elastic modulus of the base portion is lower than the elastic modulus of the array plate.
